(19) United States
(12) Patent Application Publication
(10) Pub. No.: US 2002/0100194 A1
(43) Pub. Date: Aug. 1, 2002

(54) Printed Label with electron beam cured coating

(76) Inventors: Scott W. Huffer, Hartsville, SC (US); Jeffrey M. Schuetz, Florence, SC (US)

Correspondence Address: DRINKER BIDDLE & REATH, ONE LOGAN SQUARE, 18TH AND CHERRY STREETS, PHILADELPHIA, PA, 19103-6996, US

(21) Appl. No.: 09/742,166

(22) Filed: Dec. 21, 2000

(51) Int. Cl. B32B 3/10; B42D 15/00

(52) U.S. Cl. 40/310; 428/54

(57) ABSTRACT

A preprinted label having an electron beam cured coating is described. The label is especially well suited for application to plastic bottles. The label is formed from a base film of oriented polypropylene on which surface printing is provided. An electron beam curable coating, formed from epoxy acrylate oligomers and acrylate monomers, is applied to the base film and cured using an electron beam.

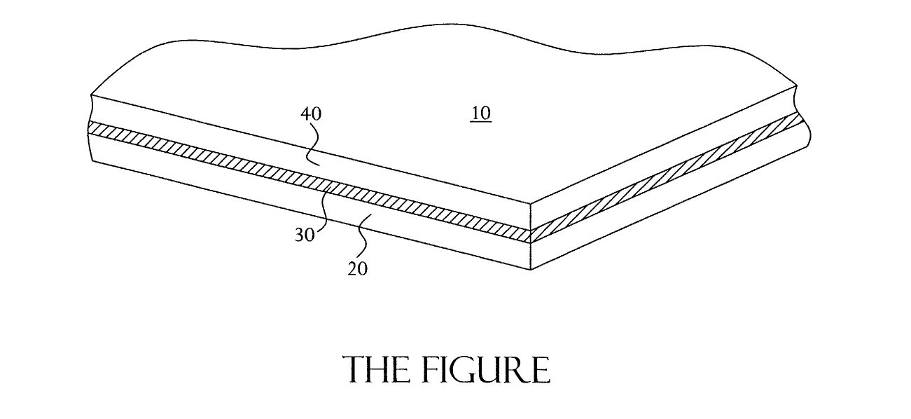

### FIELD OF THE INVENTION

The present invention relates to the field of labels and, more particularly, to the field of preprinted labels. Although preprinted labels have a wide range of use, the present invention is particularly well suited for use as a bottle label.

### BACKGROUND OF THE INVENTION

Preprinted labels serve numerous functions with regard to the sale of goods. Labels provide decorative indicia to catch the eye of a consumer, identify the nature of the product, educate the consumer as to nutritional information of consumables, and impart good will to the product by identifying its source. Labels are especially important in the sale of beverages, wherein the unlabeled products of competitors may be visually indistinguishable.

Labels for bottles are produced in various sizes and types. A common label is rectangular in shape and is affixed to the bottle using a permanent adhesive. Other bottle labels may be formed in a sleeve shape, wrapped around the body of the bottle, and heat shrunk in order to cling to the bottle. Still other labels may be wrapped around the bottle, the opposite ends of the label coming into contact and becoming adhered to each other through the use of an adhesive or a heat seal.

A beverage producer may spend substantial sums of money every year advertising its product line. Money is spent on conventional advertisements, such as television commercials, written ads in newspapers and direct mail. Money is also spent sponsoring events, on local, national and even global scales, in order to establish and maintain good will. Beverage producers go to great lengths to project an image of quality and good will because consumers often make purchasing decisions based on these intangible factors, especially when faced with the difficult choice between two beverages which some might consider very similar.

Advertising of a company's product and the projection of good will is only part of the battle to win a customer's purchase. The product itself must appear attractive, clean and well cared for before it reaches the customer. A product which appears to a consumer to be of inferior quality or which looks like it has been abused before reaching the customer may not be purchased despite all the promotional efforts of the producer. A label on a beverage bottle, for instance, does not speak well for the product contained therein if it is smeared, torn or otherwise damaged. Thus, the integrity of preprinted labels, especially the ink printed thereon, must be protected from damage, often caused by smearing through contact with solvents, as well as physical harms such as scraping or scratching.

The conventional approach to protecting the ink of a label involves laminating a clear layer of plastic film on top of the ink, thereby sandwiching the ink between a first polymer base film and the second film. A white or opaque oriented polypropylene (OPP) film is generally used to form the base layer. The white OPP film may be surface printed before an adhesive is applied. A clear plastic film, generally OPP or polyethylene terephthalate (PET) is laminated on top of the ink. Alternately, the top clear film might be reverse printed. A conventional label employing this approach may, therefore, have a structure: (1) a white opaque base coat of OPP; (2) ink; (3) adhesive; and (4) clear OPP. Although this approach has proven to be fairly effective, the two layer construction is expensive because it requires both an adhesive layer and an outer OPP or PET film. Further, a common method of manufacturing the label involves two passes across a laminator, requiring longer processing times and greater expense than a one pass process. Still more expense is incurred by the manufacturer in storing the two-ply laminate because the adhesive requires a long period of time to cure.

Other attempts to improve labels utilize ultra violet (UV) energy cured inks to reduce smearing by contact with solvents. The UV cured inks do not dissolve in most solvents, thereby preventing smearing. However, the UV curable inks can be expensive. Moreover, UV curable ink inventories require special storage, complicating the manufacturing process. In the end, the UV curable ink approach affords little protection against mechanical damage, such as scratches or scrapes.

Still another approach is to apply a UV curable coating to protect a conventional ink layer. U.S. Pat. No. 5,945,183 to Johnson discloses a sleeve label with a UV curable coating. However, UV curing can be expensive. UV curing requires the use of expensive photoinitiators which remain present in the label in a residual amount after crosslinking. The initiators can migrate and cause unpleasant odors, as well as other problems well known to those skilled in the art. Moreover, UV cured coatings are cross-linked at relatively low energy, leaving some monomer unreacted.

### SUMMARY OF THE INVENTION

The invention is directed to an improved preprinted label. The label of the present invention is considered ideal for use in the labeling of beverage bottles, to which frequent reference is made herein.

The bottle label of the present invention comprises a polymer base film, preferably oriented polypropylene (OPP). The OPP film is surface printed with desired indicia, such as trademarks, nutritional information, decorative graphics and the like. An electron beam curable coating is coated on to the base film, covering the ink printed thereon. The film is electron beam cured, whereby the electron beam curable coating is crosslinked. Once the electron beam curable coating has been crosslinked, the film is cut into desired size labels.

### BRIEF DESCRIPTION OF THE DRAWING

For the purpose of illustrating the invention, there is shown in the drawing a form which is presently preferred; it being understood, that this invention is not limited to the precise arrangement and instrumentalities shown.

The Figure is a schematic cross sectional view of a label according to the present invention.

### DETAILED DESCRIPTION OF THE DRAWING

With reference to the Figure, there is shown a label generally identified by the numeral 10. The label 10 is a preprinted label suitable for use with an article for sale in the stream of commerce. The label 10 is ideal for use on bottles, such as plastic bottles generally formed from polyethylene terephthalate.

The label 10 is formed using a plastic web, which in the finished label is a base film layer 20. The film layer 20 is formed from a polymer. Preferably, film layer 20 is formed from a thermoplastic polymer, most preferably oriented polypropylene. The film layer 20 is optionally opaque white.

The film layer 20 is preferably surface printed with any acceptable printing technique, such as the use of a flexographic printing unit, well known to those skilled in the art. The film layer 20 is optionally treated by well known techniques such as corona discharge before ink application. Alternate means for printing on a thermoplastic web are equally well known. The printing unit applies an ink layer 30 to film layer 20. The printing may contain indicia to identify the source of the goods on which the label 10 is to be affixed. The printing might also contain nutritional information or other facts relevant to a potential purchaser, such as price. Ideally, the printed image is eye catching and attractive to the consumer, thereby enticing a sale of the goods to which label 10 is affixed. The film is preferably run through a drying unit to dry the ink layer 30.

An electron beam curable coating 40 is coated on to the film layer 20, thereby sandwiching ink layer 30 between the electron beam curable coating 40 and film layer 20. Most any conventional coating unit, well known to those skilled in the art, may be employed for this purpose. The electron beam curable coating 40 may comprise a number of species of suitable compounds. One group of compounds which has been found to be suitable is sold by Rohm & Haas under the registered trademark MOR-QUIK, owned by Morton International, Inc., a subsidiary of Rohm & Haas. The materials best suited for the coating 40 are a combination of oligomers and monomers. The preferred oligomer is an epoxy acrylate. The preferred monomer is an acrylate. The monomers act as diluents, used to reduce the viscosity of the coating for application purposes. The concentration of monomer is adjustable to provide a wide range of viscosity, such that many conventional coating systems may be employed to apply the electron beam curable coating. The blend ratio of oligomer and monomer also controls physical properties and adhesion of the coating.

Various desirable additives, the exact nature of which will depend on the specifications of the label desired, may also be added. Often, defoamers and slip agents are desirable. It is well known to provide such additives to polymer films to improve various qualities such as coefficient of friction, gloss, and processing qualities. The additives provided with the label of the present invention become “reacted-in” during crosslinking of the electron beam curable coating. For example, the slip agents, provided to improve the coefficient of friction, are fixed in the crosslinking process, and are therefore not susceptible to the common problems associated with slip agent migration in laminates. The stability of the electron beam curable coating and its additives therefore allows for greater control of the gloss and slip qualities of the label, allowing a manufacturer to create labels according to demanding specifications.

The electron beam curable coating 40 is cured using a suitable electron beam source. Suitable electron beam sources may be obtained commercially from Energy Science, Inc. of Wilmington, Mass.

The amount of energy absorbed, also known as the dose, is measured in units of MegaRads (MR or Mrad) or kiloGrays (kGy), where one Mrad is 10 kGy, one kGy being equal to 1,000 Joules per kilogram. The electron energy output should be within the range of 110 keV to 170 keV at a dosage of 2.5 to 5.0 MegaRads. Preferably, the energy is within the range of 125 keV to 135 keV at a dosage of 3.0 to 4.0 MegaRads.

When exposed to an electron beam from a suitable source, acrylate monomer reacts with the epoxy acrylate chains to form crosslinks. The precursor molecules are excited directly by the ionizing electron beam. Therefore no initiator compounds are required, so no residual volatile organic compounds are present in the finished product. Moreover, curing is substantially instantaneous and provides a cure percentage at or near one hundred percent.

It has been found that the electron beam curable coating of the present invention can be processed at manufacturing speeds in excess of 1000 feet per minute. Such processing speeds are a great improvement over typical lamination speeds which are about 600 feet per minute.

Further, the label of the present invention can be less costly to produce than the conventional label. Production is less expensive because a second polyolefin web is not required. Moreover, no adhesive is required to bond a second web to the polymer base film.

The label of the present invention may be manufactured by a process involving a series of rollers, a printing station, means to coat the electron beam curable coating on to the film, and an electron beam source. U.S. Pat. No. 5,945,183 to Johnson, incorporated herein by reference, shows a method of manufacturing a sleeve label having an ultra violet radiation curable coating. A manufacturing process such as that disclosed in Johnson, may be modified to produce the label of the present invention by removal of the ultra violet coating and curing elements and incorporation of an electron beam curable coating means and a suitable electron beam source for curing the coating.

One suitable manufacturing process for making a label with an electron beam cured coating involves the steps of providing a base polymer film in a continuous roll; printing an image on the base polymer film; coating the base polymer film with an electron beam curable coating, thereby sandwiching the ink image between the base film and the coating; curing the coating with an electron beam; and cutting the resultant composite into the desired shape of a label. When used as a bottle label, the label is preferably applied by wrapping the label around the body of the bottle and heat sealing the opposite ends of the label together to form a seal seam parallel to the longitudinal axis of the bottle. However, the label can alternatively be applied to an article using an adhesive.

The present invention may be embodied in other specific forms without departing from the spirit or essential attributes thereof and, accordingly, reference should be made to the appended claims, rather than to the foregoing specification, as indicating the scope of the invention.

What is claimed is:

1. A label comprising in order:
a film layer;
ink printed on a first side of the film layer; and
an electron beam cured layer coated on the first side of the film layer.

2. The label of claim 1 wherein the film layer is a thermoplastic.

3. The label of claim 2 wherein the film layer is oriented polypropylene.

4. The label of claim 1 wherein the electron beam cured layer is formed from a combination of oligomers and monomers.

5. The label of claim 4 wherein the oligomer is an epoxy acrylate.

6. The label of claim 4 wherein the monomer is an acrylate.

7. The label of claim 1 wherein the electron beam cured layer is cured by an electron beam having an energy of from about 110 keV to about 170 keV.

8. The label of claim 7 wherein the electron beam cured layer is cured by an electron beam having an energy of from about 125 keV to about 135 keV.

9. The label of claim 1 wherein the electron beam cured layer is cured by absorbing a dosage of from about 2.5 to about 5.0 MegaRads.

10. The label of claim 9 wherein the electron beam cured layer is cured by absorbing a dosage of from about 3.0 to about 4.0 MegaRads.

11. A bottle label comprising:
a base polymer layer;
an electron beam cured coating coated on the base polymer layer; and
ink disposed between the base polymer layer and the electron beam cured coating.

12. The label of claim 11 wherein the film layer is a thermoplastic.

13. The label of claim 12 wherein the film layer is oriented polypropylene.

14. The label of claim 11 wherein the electron beam cured layer is formed from an epoxy acrylate oligomer and an acrylate monomer.

15. The label of claim 11 wherein the label has two opposite edges, the two opposite edges being heat sealable to one another.

16. A method of producing a bottle label comprising:
providing a base polymer film;
printing an image on the base polymer film;
coating the base polymer film with an electron beam curable coating; and
curing the coating with an electron beam.

17. The method of producing a bottle label of claim 16 wherein curing the coating with an electron beam comprises exposing the electron beam curable coating to an electron beam having energy of from about 110 keV to 170 keV at a dosage of from about 2.5 to 5.0 MegaRads.

18. The method of producing a bottle label of claim 16 further comprising cutting the film with the cured coating thereon into a predetermined shape.
